(19) United States
(12) Patent Application Publication
(10) Pub. No.: US 2016/0320296 A1
(43) Pub. Date: Nov. 3, 2016

(54) GAS DETECTOR

(71) Applicant: Konica Minolta, Inc., Tokyo (JP)

(72) Inventors: Motohiro Asano, Osaka (JP); Hiroyoshi Hashino, Tokyo (JP); Yoshitaka Yokoyama, Tokyo (JP)

(73) Assignee: Konica Minolta, Inc., Tokyo (JP)

(21) Appl. No.: 15/141,236

(22) Filed: Apr. 28, 2016

(30) Foreign Application Priority Data
Apr. 28, 2015 (JP) 2015-091441

(51) Int. Cl. G01N 21/3518; G01J 5/10; G01J 5/00

(52) U.S. Cl. CPC G01N 21/3518; G01J 5/0014; G01J 5/10; G01N 2021/3129

(57) ABSTRACT

A gas detector includes: an infrared camera that images a gas; and a controller including at least an electronic component, wherein the controller determines a temperature range of the infrared camera in which the gas can be imaged, and detects the gas from moving infrared images taken for a predetermined period of time in the temperature range determined.

The entire disclosure of Japanese Patent Application No. 2015-091441 filed on Apr. 28, 2015 including description, claims, drawings, and abstract are incorporated herein by reference in its entirety.

### BACKGROUND OF THE INVENTION

1. Field of the Invention

The present invention relates to a gas detector for detecting a gas present in a predetermined area.

2. Description of the Related Art

It is feared that the age deterioration of facilities such as chemical plants, for example, corrosion of pipes, tanks, and the like will cause gas leak accidents. Thus, gas detectors that utilize inherent optical absorption characteristics of gases for detecting leaking gases have been proposed. Examples of them are disclosed in JP 2011-237213 A and JP 2012-058093 A.

A gas detector described in JP 2011-237213 A includes two infrared cameras. One of the two infrared cameras detects infrared radiation in a wavelength range W1 that is a gas absorption wavelength band, and the other detects infrared radiation in a wavelength range W2 that includes the wavelength range W1 and is a wider band than the wavelength range W1. The gas detector can detect a gas by determining a difference and a ratio between detected data pieces when images are taken using the two infrared cameras.

A gas detector described in JP 2012-058093 A includes an infrared camera that detects only infrared radiation in a gas absorption wavelength band. The infrared camera takes infrared images at predetermined time intervals. The gas detector can detect a gas by extracting dynamic fluctuations based on a plurality of infrared images arranged on a time-series basis.

However, in order to detect a gas with high accuracy, it is necessary to suitably set a temperature range, one of the imaging conditions of an imaging unit having an infrared camera or the like. The conventional arts do not give consideration to the temperature range. As for the temperature range, only slightly different imaging situations such as day and night and sunny weather and cloudy weather result in different suitable temperature ranges for imaging a gas. In particular, when mid-infrared radiation is used to detect a gas, and when an apparent temperature increases due to the effect of sunlight reflection or the like, the temperature range is increased, causing saturation of a part of an image area, and making it difficult to detect the gas.

### SUMMARY OF THE INVENTION

One or more embodiments of the invention provide a gas detector that can suitably set a temperature range, one of the imaging conditions of an imaging unit for gas detection, and can detect a gas with high accuracy.

According to one or more embodiments, a gas detector comprises: an infrared camera that images a gas; and a controller including at least an electronic component, wherein the controller determines a temperature range of the infrared camera in which the gas can be imaged, and detects the gas from moving infrared images taken for a predetermined period of time in the temperature range determined.

This configuration allows the temperature range of the infrared camera in which the gas can be imaged to be determined. This makes it possible to accommodate imaging situations such as monitoring time periods and weathers to detect a gas from the image imaged by the infrared camera.

In the gas detector with the above configuration, the controller determines the temperature range before or after moving images are taken by the infrared camera.

In the gas detector with the above configuration, the controller detects the gas from the moving infrared images by moving object detection processing.

In the gas detector with the above configuration, the temperature range has a predetermined temperature upper limit and a predetermined temperature lower limit.

In the gas detector with the above configuration, a determination of presence or absence of the gas is performed based on a result of gas detection by the controller.

In the gas detector with the above configuration, an area where the gas is present is estimated based on a result of gas detection by the controller.

In the gas detector with the above configuration, the controller determines the temperature range in which a background of an image area imaged by the infrared camera can be imaged.

In the gas detector with the above configuration, a monitoring area is set in a portion in an image area imaged by the infrared camera, and the temperature range of the infrared camera in which the gas can be imaged in the monitoring area is determined.

In the gas detector with the above configuration, a plurality of section monitoring areas is set in a portion in an image area imaged by the infrared camera and is imaged in a plurality of the different temperature ranges, and the gas is detected from moving infrared images taken in the different temperature ranges for each of the section monitoring areas.

In the gas detector with the above configuration, the monitoring area or the section monitoring areas extending asymmetrically in upper and lower directions with respect to a monitoring reference position are set in a portion in an image area imaged by the infrared camera.

In the gas detector with the above configuration, the infrared camera has an infrared sensor as an image pickup device, and changes an integration time of electric signals corresponding to pixels of the infrared sensor or changes a reference potential of the infrared sensor to switch the temperature range.

In the gas detector with the above configuration, the infrared camera has an infrared sensor as an image pickup device and a filter through which infrared radiation passes, and switches the temperature range by selecting use or disuse of the filter, or providing a plurality of types of the filters that transmit different wavelength bands of infrared radiation and switching them, or using the filter that can change the wavelength band of infrared radiation it transmits or transmittance.

### BRIEF DESCRIPTION OF THE DRAWINGS

Advantages and features of embodiments of the present invention will become more fully understood from the detailed description given hereinbelow and the appended drawings which are given by way of illustration only, and thus are not intended as a definition of the limits of the present invention, and wherein:

FIG. 1 is a schematic block diagram of a gas detector according to a first embodiment of the present invention;

FIG. 2 is an explanatory diagram illustrating a situation of gas leak detection by an imaging unit of the gas detector according to the first embodiment of the present invention;

FIG. 3 is an explanatory diagram illustrating an outline of a flow of gas detection processing by the gas detector according to the first embodiment of the present invention;

FIG. 4 is a flowchart illustrating the gas detection processing by the gas detector according to the first embodiment of the present invention;

FIG. 5 is a flowchart illustrating imaging condition determination processing in the gas detection processing by the gas detector according to the first embodiment of the present invention;

FIG. 6 is an image taken in effective pixel checking processing (temperature range of 10° C. to 60° C.) in the imaging condition determination processing in the gas detection processing by the gas detector according to the first embodiment of the present invention;

FIG. 7 is a histogram of the image shown in FIG. 6;

FIG. 8 is an image taken in the effective pixel checking processing (temperature range of 85° C. to 140° C.) in the imaging condition determination processing in the gas detection processing by the gas detector according to the first embodiment of the present invention;

FIG. 9 is a histogram of the image shown in FIG. 8;

FIG. 10 is an explanatory diagram illustrating, for each process, results of the gas detection processing by the gas detector according to the first embodiment of the present invention;

FIG. 11 is a gas image as a final result of the gas detection processing by the gas detector according to the first embodiment of the present invention;

FIG. 12 is an explanatory diagram illustrating an outline of a flow of gas detection processing by a gas detector according to a second embodiment of the present invention;

FIG. 13 is a flowchart illustrating the gas detection processing by the gas detector according to the second embodiment of the present invention;

FIG. 14 is an image taken in effective pixel checking processing (temperature range of 85° C. to 140° C.) in imaging condition determination processing in the gas detection processing by the gas detector according to the second embodiment of the present invention;

FIG. 15 is a histogram of the image shown in FIG. 14;

FIG. 16 is an image taken in the effective pixel checking processing (temperature range of 10° C. to 60° C.) in the imaging condition determination processing in the gas detection processing by the gas detector according to the second embodiment of the present invention;

FIG. 17 is a histogram of the image shown in FIG. 16;

FIG. 18 is an explanatory diagram illustrating an area monitored by a gas detector according to a third embodiment of the present invention;

FIG. 19 is an explanatory diagram illustrating an image area of an imaging unit of a gas detector according to a fourth embodiment of the present invention; and

FIG. 20 is an explanatory diagram illustrating areas monitored by the gas detector according to the fourth embodiment of the present invention.

### DESCRIPTION OF THE EMBODIMENTS

Hereinafter, an embodiment of the present invention will be described with reference to the drawings. However, the scope of the invention is not limited to the illustrated examples.

### First Embodiment

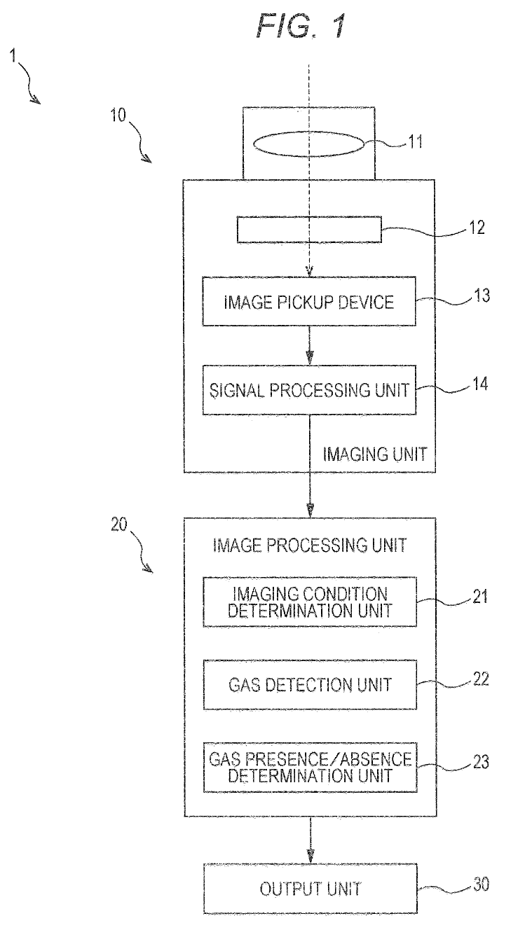

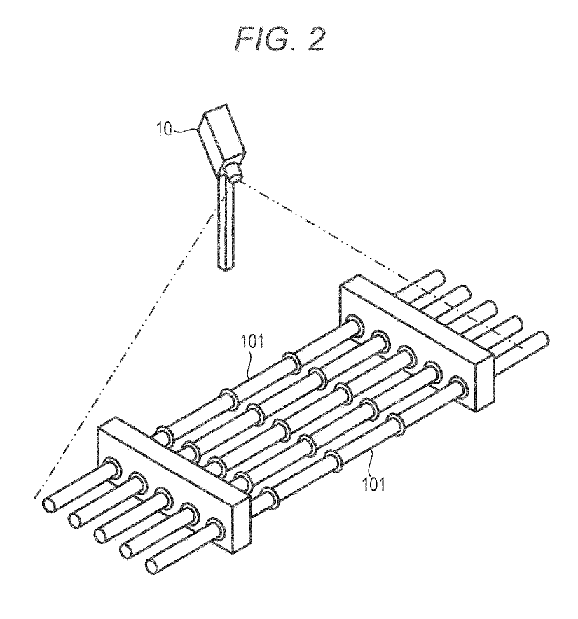

First, a configuration of a gas detector according to a first embodiment of the present invention will be described with reference to FIGS. 1 and 2. FIG. 1 is a schematic block diagram of the gas detector. FIG. 2 is an explanatory diagram illustrating a situation of gas leak detection by an imaging unit of the gas detector.

A gas detector 1 is an apparatus that is installed, for example, in a factory or the like to detect gas leaks from pipes 101 described below or the like. As shown in FIG. 1, the gas detector 1 includes an imaging unit 10, an image processing unit 20, and an output unit 30.

As shown in FIG. 2, for example, the imaging unit 10 is installed at a distance with respect to the pipes 101 to be monitored, to be able to image the pipes 101 and the surrounding area. The imaging unit 10 includes a lens 11, a filter 12, an image pickup device 13, and a signal processing unit 14 shown in FIG. 1. The imaging unit 10 is an infrared camera with an infrared sensor as the image pickup device 13, and is provided to detect the presence of a gas leaked from the pipes 101 from an image.

A colorless, transparent gas can be detected by capturing a temperature change in a space (area) where the gas is present. Temperature change that influences the detection of a gas greatly depends on the product of the concentration and thickness of the gas, and the difference between the apparent temperature of an object imaged by the imaging unit 10 and the temperature of the gas. Therefore, when the temperature range (imaging condition) of the imaging unit 10 is off the temperature of an object at which the gas can be detected, there is a fear that the gas cannot be detected. In particular, when the apparent temperature range of objects in an image area imaged by the imaging unit 10 is relatively wide (e.g. 0° C. to 140° C.), imaging once cannot detect the gas for all portions in the image area. The gas detector 1 in this embodiment solves this problem, and allows high-accuracy detection of the gas.

The product of concentration and thickness means the product of the concentration of a target gas and the thickness (depth) of a space where the target gas is present in relation to the direction of imaging by the imaging unit 10, and is expressed in units of [%·m] or [ppm·m].

Infrared radiation emitted by the gas and the background of a space (area) where the gas is present enters the image pickup device 13 through the lens 11 and the filter 12. Gas detection utilizes the infrared absorption wavelengths of the target gas. Thus, for the filter 12, a bandpass filter that appropriately transmits the infrared absorption wavelength range of the target gas is used. The filter 12 may alternatively be disposed between an object and the lens 11. When detection of infrared radiation is performed in the infrared absorption wavelength range of the gas, the amount of infrared radiation emitted by the background of the space (area) where the gas is present changes, depending on the presence or absence of the gas. Then, by detecting infrared radiation in a wavelength range emitted by the background and determining a difference, the gas can be detected.

Thus, a known background subtraction method can be used for gas detection (moving object detection). For example, a method described in “Chris Stauffer and W. E. L Grimson, ‘Adaptive background mixture models for real-time tracking,’ The Artificial Intelligence Laboratory, Massachusetts Institute of Technology, IEEE DOI:10.1109/CVPR.1999.784637” can be used. Alternatively, other background subtraction methods may be used for gas detection. Alternatively, another technique such as a temporal subtraction method that compares temporal differences between images taken at different times, and detects a gas (moving object) from the difference may be used.

The signal processing unit 14 performs signal processing on a detected signal output by the image pickup device 13 for identifying the gas. A signal processed by the signal processing unit 14 is transmitted to the image processing unit 20.

The image processing unit 20 obtains an output signal from the imaging unit 10, and performs determination of an imaging condition and image processing for performing detection of the gas leaked. The image processing unit 20 includes an imaging condition determination unit 21, a gas detection unit 22, and a gas presence/absence determination unit 23. The image processing unit 20 includes at least a microprocessor.

The imaging condition determination unit 21 is provided to determine a temperature range (imaging condition) of the imaging unit 10 in which the gas can be imaged. The imaging condition determination unit 21 determines in what temperature range of a plurality of temperature ranges predetermined as required, moving object detection processing is performed.

The gas detection unit 22 performs image processing on a signal imaged by the imaging unit 10 in a temperature range determined by the imaging condition determination unit 21 and output to detect the gas (moving object). The gas detection unit 22 performs image processing related to moving object detection using the above-described background subtraction method or the like in the moving object detection processing.

The gas presence/absence determination unit 23 performs a final gas presence/absence determination, based on the results of the moving object detection processing performed by the gas detection unit 22. The gas presence/absence determination unit 23 determines that the gas is present in the image area imaged by the imaging unit 10, based on the fact that a moving object with a predetermined number of pixels has been detected. As a result of the gas presence/absence determination processing, image information having been subjected to the image processing by the gas detection unit 22, numerical information on the presence or absence of the gas as an alternative to an image, or the like is transmitted to the output unit 30.

The output unit 30 receives information output by the image processing unit 20 after performing the image processing. The output unit 30 includes a display unit not shown, for example, and displays a detected gas leak situation on the display unit. Alternatively, the output unit 30 may include a speaker not shown and give notification of a gas leak by sound.

The gas detector 1 further includes a controller not shown consisting of an operating unit, a storage unit, and other electronic components (electronic circuit). The controller controls a series of operations related to gas detection, display, and others on the imaging unit 10, the image processing unit 20, and the output unit 30, based on a program and data stored and input in advance in the storage unit or the like.

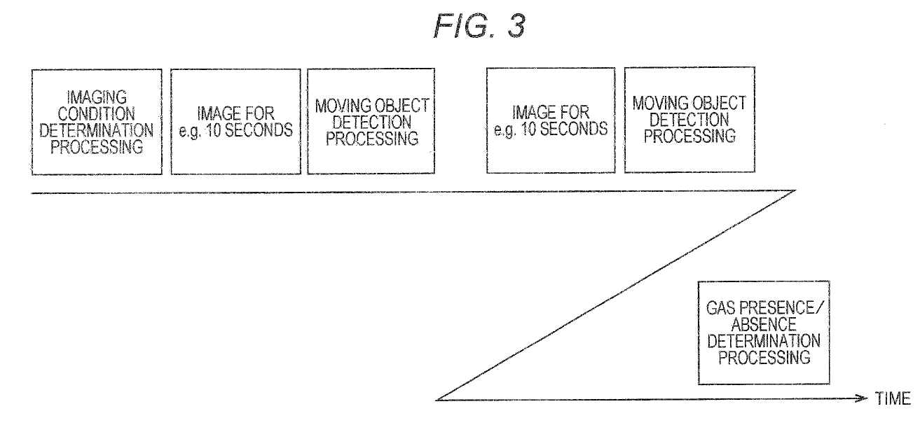

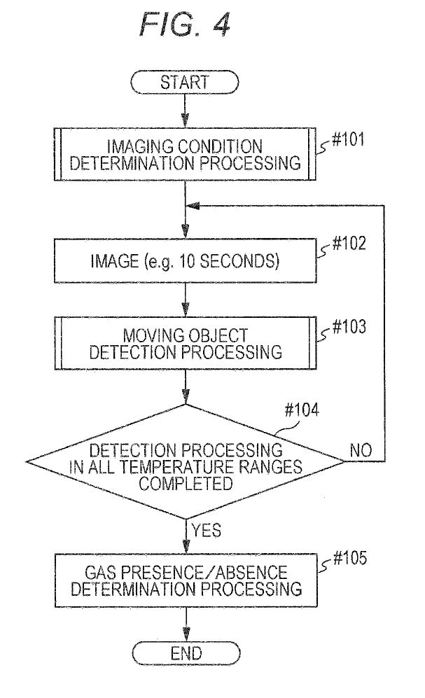

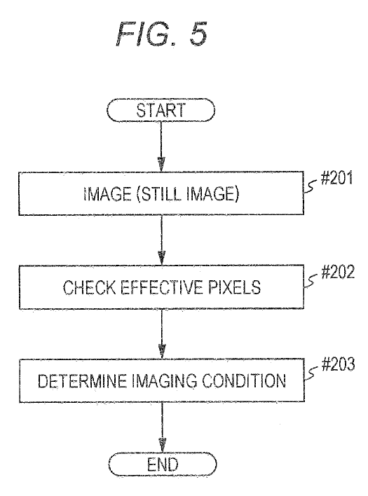

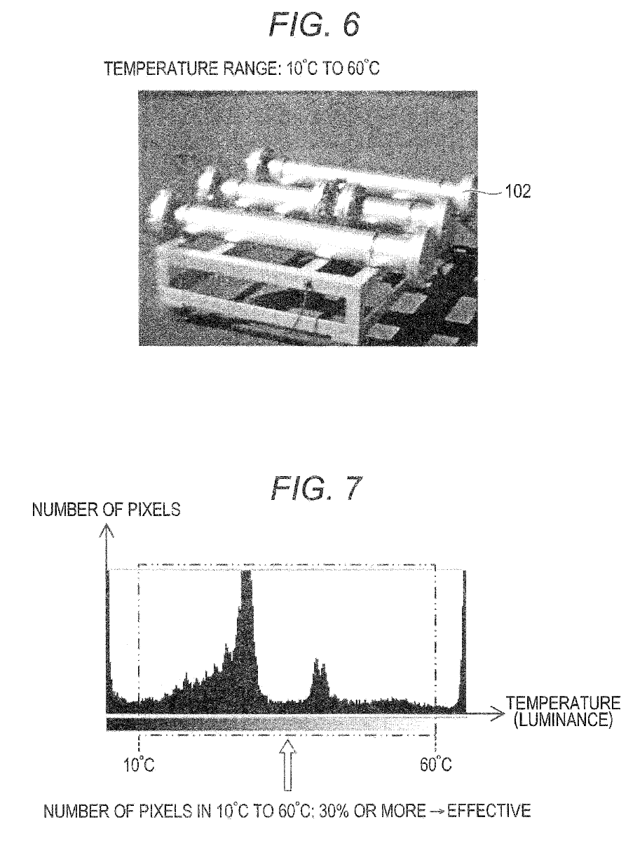

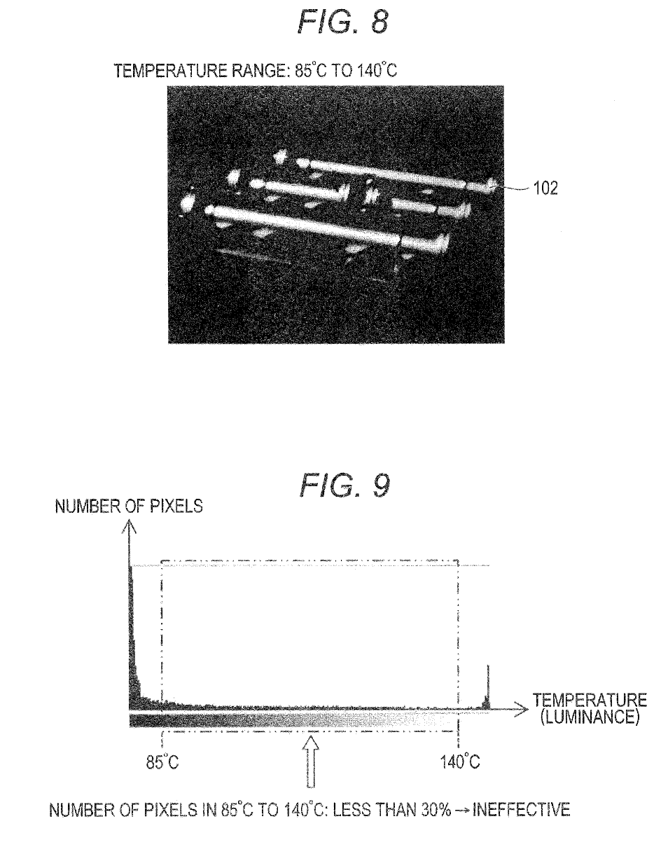

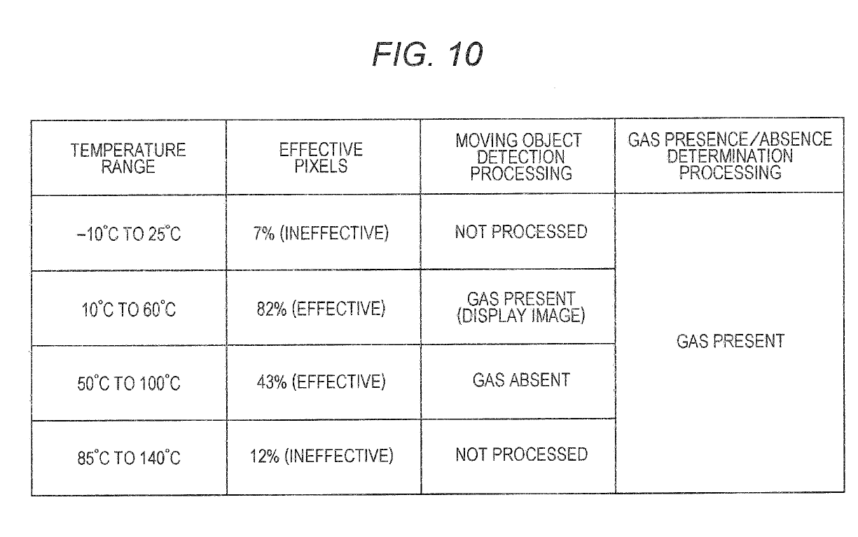

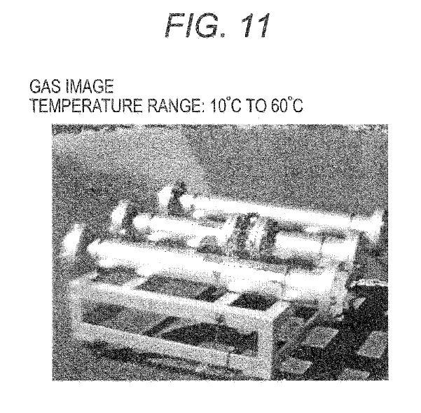

Next, the gas detection processing by the gas detector 1 will be described with reference to FIGS. 3 to 11. FIG. 3 is an explanatory diagram illustrating an outline of a flow of the gas detection processing. FIGS. 4 and 5 are a flowchart illustrating the gas detection processing and a flowchart illustrating the imaging condition determination processing in the gas detection processing. FIGS. 6 and 7 are an image taken in a temperature range of 10° C. to 60° C. in an effective pixel checking processing in the imaging condition determination processing and a histogram of the image. FIGS. 8 and 9 are an image taken in a temperature range of 85° C. to 140° C. in the effective pixel checking processing in the imaging condition determination processing and a histogram of the image. FIGS. 10 and 11 are an explanatory diagram illustrating, for each process, results of the gas detection processing and a gas image as a final result of the gas detection processing.

In the gas detector 1 in this embodiment, as shown in FIG. 3, first, the imaging condition determination unit 21 performs the imaging condition determination processing to determine at least one temperature range in which to perform the gas detection processing, of a plurality of predetermined temperature ranges. As the plurality of temperature ranges, for example, four temperature ranges, −10° C. to 25° C., 10° C. to 60° C., 50° C. to 100° C., and 85° C. to 140° C., are preset. Each temperature range has a predetermined temperature upper limit and a predetermined temperature lower limit.

As for an image taken by an infrared camera, the imaging unit 10, the luminance, brightness of each pixel uniquely corresponds to a temperature by a typical conversion equation. That is, the temperature of an object can be obtained from the luminance, brightness of pixels of an image.

As a technique of switching temperature ranges of an infrared camera, for example, by changing the integration time of electric signals corresponding to pixels of an infrared sensor, or by changing the reference potential of an infrared sensor, the output signal level is changed, and by reflecting it in pixels of an image, the temperature ranges can be switched. Alternatively, for example, a plurality of types of filters 12 that transmit different wavelength bands of infrared radiation is prepared, and by switching them hardware-wise, temperature ranges can be switched. As for switching of temperature ranges using the filter 12, a switch may be made by selecting the use or disuse of a filter 12, or a switch may be made using a filter 12 that can change the wavelength band of infrared radiation it transmits or transmittance. Alternatively, other known techniques of switching temperature ranges of infrared cameras can be used.

When the imaging condition determination unit 21 determines two temperature ranges, for example, subsequently, in each of the two temperature ranges, imaging by the imaging unit 10 and moving object detection processing by the gas detection unit 22 on an image taken are performed. Thereafter, based on the results of the moving object detection processing, the gas presence/absence determination unit 23 performs a final gas presence/absence determination.

Next, the gas detection processing by the gas detector 1 will be described in more detail along flows shown in FIGS. 4 and 5.

For example, based on a predetermined gas monitoring schedule or the like, the gas detection processing by the gas detector 1 is started (START in FIG. 4).

In step #101, processing of determining a temperature range (imaging condition) of the imaging unit 10 in which a gas can be imaged is performed by the imaging condition determination unit 21. For the imaging condition determination processing, the processing moves to the flow shown in FIG. 5.

When the imaging condition determination processing is started (START in FIG. 5), in step #201, a still image is taken in each of the above-described four temperature ranges (−10° C. to 25° C., 10° C. to 60° C., 50° C. to 100° C., and 85° C. to 140° C.). For example, an image taken in a temperature range of 10° C. to 60° C. is shown in FIG. 6, and an image taken in a temperature range of 85° C. to 140° C. is shown in FIG. 8. On the images, a scene (background) of a place to be monitored is imaged, and a plurality of pipes 102 for which to detect gas leaks can be seen.

In step #202, checking of effective pixels is performed on the images taken in the four temperature ranges. The effective pixel checking is performed using a histogram in which a pixel distribution in a still image is plotted by temperature (luminance, brightness). For example, a histogram of the image taken in a temperature range of 10° C. to 60° C. is shown in FIG. 7, and a histogram of the image taken in a temperature range of 85° C. to 140° C. is shown in FIG. 9.

In the effective pixel checking, when the percentage of pixels in a predetermined temperature range in each histogram is 30% or more, for example, it is regarded as effective, and when it is less than 30%, it is regarded as ineffective. For example, a temperature range of 10° C. to 60° C. shown in FIG. 7 is confirmed to be effective from the histogram since the number of pixels in a temperature range of 10° C. to 60° C. is 30% or more. The temperature range of 85° C. to 140° C. shown in FIG. 9 is confirmed to be ineffective from the histogram since the number of pixels in a temperature range of 85° C. to 140° C. is less than 30%.

In an example with reference to FIGS. 7 and 9, effective pixels are checked only at temperatures at which gas detection accuracy can be assured (temperatures at which the SN ratio (signal-to-noise ratio) is allowable). Alternatively, they may be checked by determining whether the pixel values of an image are saturated or not.

In step #203, a temperature range confirmed to be effective in step #202 is determined as an imaging condition. For example, here, assume that two temperature ranges, 10° C. to 60° C. and 50° C. to 100° C., are determined as imaging conditions.

When the imaging conditions are determined, the imaging condition determination processing is completed (END in FIG. 5), and the processing returns to the flow shown in FIG. 4 and proceeds to step #102.

In step #102, imaging by the imaging unit 10 is performed. For imaging, for example, moving images are taken for ten seconds in a temperature range of 10° C. to 60° C. determined as the imaging condition. The imaging time of ten seconds is an example, and can be changed as desired.

In step #103, the gas (moving object) detection processing on infrared images taken in step #102 is performed by the gas detection unit 22. The gas detection unit 22 performs image processing related to moving object detection using the above-described background subtraction method or the like in the moving object detection processing.

In step #104, it is determined whether the moving object detection processing in all the temperature ranges determined by the imaging condition determination unit 21 has been completed or not. When the moving object detection processing in another temperature range (50° C. to 100° C.) is still left, the processing returns to step #102 to perform imaging and the moving object detection processing. When the moving object detection processing in all the temperature ranges is completed, the processing proceeds to step #105.

In step #105, a final gas presence/absence determination is performed by the gas presence/absence determination unit 23, based on the results of the moving object detection processing performed by the gas detection unit 22. Then, the gas detection processing by the gas detector 1 is completed (END in FIG. 4).

FIG. 10 shows the results of the gas detection processing performed as described above for each process. In two temperature ranges of −10° C. to 25° C. and 85° C. to 140° C., the moving object detection processing is not performed since a predetermined number of effective pixels cannot be seen in the still images in the imaging condition determination processing. On the other hand, in two temperature ranges of 10° C. to 60° C. and 50° C. to 100° C., the moving object detection processing is performed since the predetermined number of effective pixels can be seen in the still images in the imaging condition determination processing.

In the moving object detection processing, the gas is detected in a temperature range of 10° C. to 60° C., and the gas is not detected in a temperature range of 50° C. to 100° C. Then, by the final gas presence/absence determination processing, gas presence is determined. As a result, for example, an image shown in FIG. 11 is displayed on the display unit or the like of the output unit 30. In FIG. 11, the presence of the gas considered to have leaked from the pipes 102 is drawn in such a manner as to be visually discernible. That is, an area where the gas is present can also be estimated based on the results of the gas detection by the gas detection unit 22.

### Second Embodiment

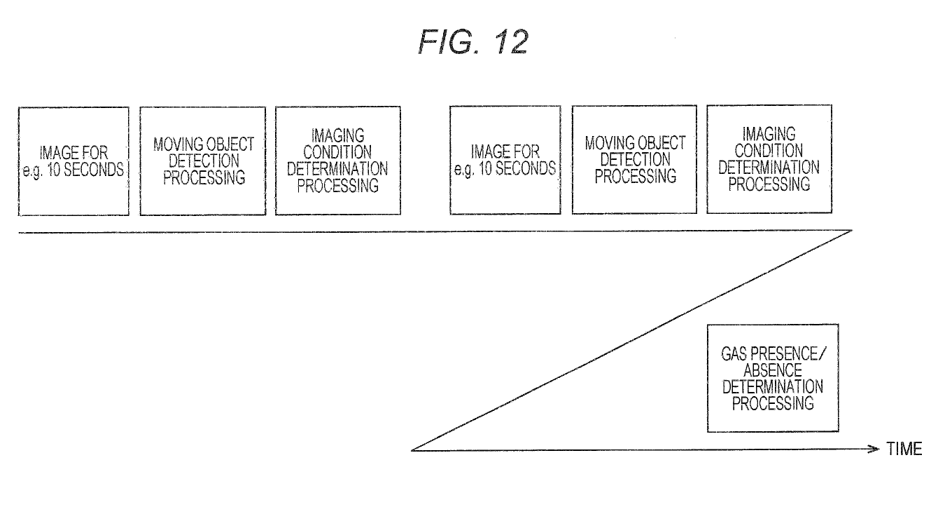

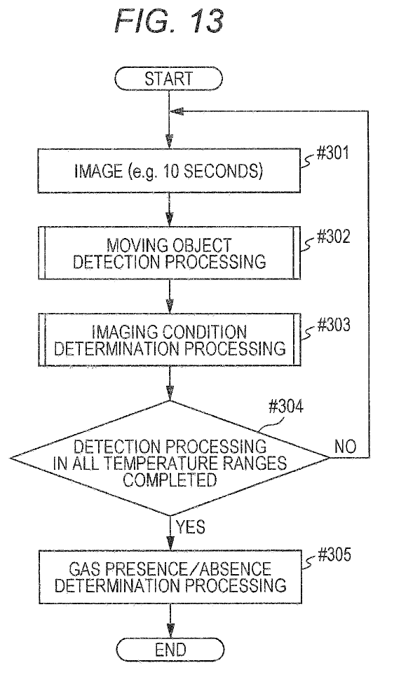

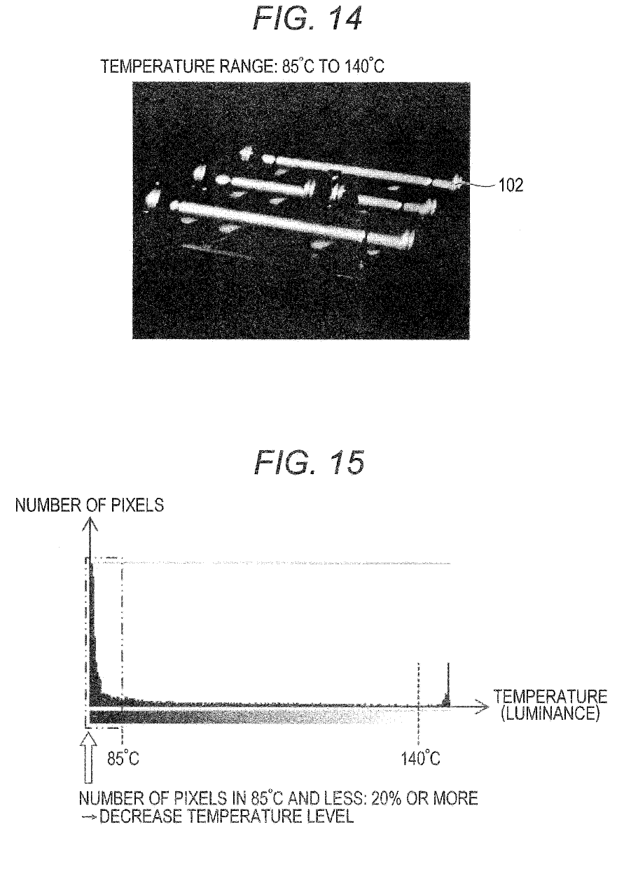

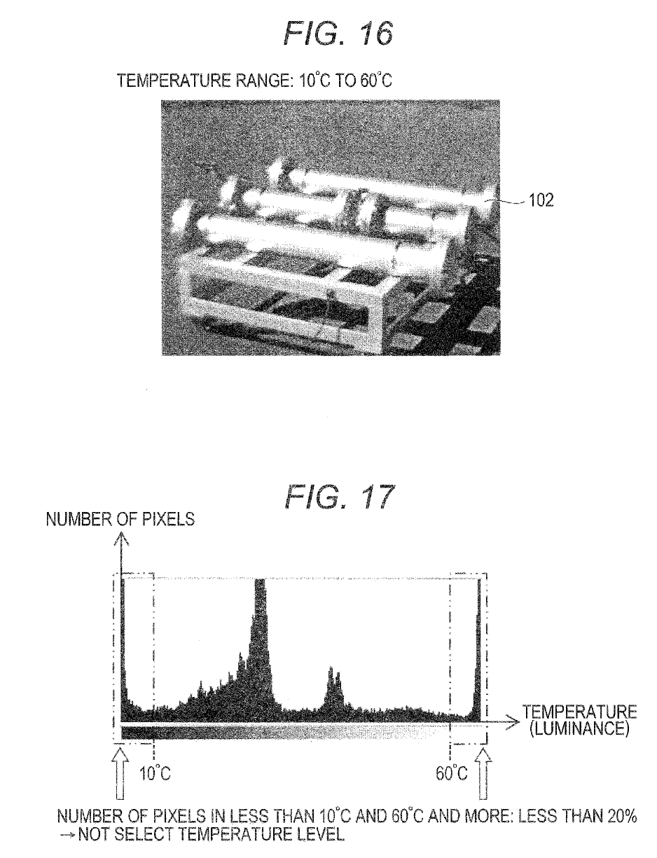

Next, a gas detector according to a second embodiment of the present invention will be described with reference to FIGS. 12 to 17. FIGS. 12 and 13 are an explanatory diagram illustrating an outline of a flow of gas detection processing by the gas detector and a flowchart illustrating the gas detection processing. FIGS. 14 and 15 are an image taken in a temperature range of 85° C. to 140° C. in effective pixel checking processing in imaging condition determination processing and a histogram of the image. FIGS. 16 and 17 are an image taken in a temperature range of 10° C. to 60° C. in the effective pixel checking processing in the imaging condition determination processing and a histogram of the image. A basic configuration of this embodiment is identical to that of the first embodiment described earlier, and thus components identical to those in the first embodiment are denoted by the same reference numerals as before and will not be described.

In a gas detector 1 in the second embodiment, as shown in FIG. 12, first, moving images are taken in a predetermined temperature range (e.g. 85° C. to 140° C.) by an imaging unit 10, and moving object detection processing on infrared images taken is performed by a gas detection unit 22. Thereafter, based on the results of the moving object detection processing, an imaging condition determination unit 21 performs processing of determining another temperature range (imaging condition) in which to perform the moving object detection processing.

Subsequently, moving images are taken by the imaging unit 10 in the other temperature range, and the moving object detection processing on images taken is performed by the gas detection unit 22. Thereafter, based on the results of the moving object detection processing, the imaging condition determination unit 21 performs processing of determining still another temperature range in which to perform the moving object detection processing. When there are no other temperature ranges in which to perform the moving object detection processing, a gas presence/absence determination unit 23 performs a final gas presence/absence determination.

FIG. 12 shows an example of repeating a flow of a series of processing of imaging, moving object detection processing, and imaging condition determination processing on two temperature ranges.

As for the flow of the gas detection processing by the gas detector 1 shown in FIG. 13, in step #301, imaging by the imaging unit 10 is performed. For imaging, for example, moving images are taken for ten seconds in a temperature range of 85° C. to 140° C. predetermined as an imaging condition. On these images, in step #302, gas (moving object) detection processing by the gas detection unit 22 is performed. An image taken in a temperature range of 85° C. to 140° C. (still image at a predetermined time of the moving images) is shown in FIG. 14.

In step #303, processing of determining a temperature range of the imaging unit 10 in which a gas can be imaged is performed by the imaging condition determination unit 21. The imaging condition determination unit 21 checks the percentages of pixels in a temperature range of less than 85° C. on the low-temperature side and in a temperature range of 140° C. and more on the high-temperature side, using a histogram (see FIG. 15) of the image taken in a temperature range of 85° C. to 140° C. When the percentage of pixels in either of the temperature ranges is 20% or more, for example, it is determined that imaging and the moving object detection processing is performed in another temperature range. Since the number of pixels in a temperature range of less than 85° C. is 20% or more in the histogram of a temperature range of 85° C. to 140° C. shown in FIG. 15, a temperature range of 50° C. to 100° C. is next determined as an imaging condition.

In step #304, it is determined whether the moving object detection processing in a temperature range determined by the imaging condition determination unit 21 has been completed or not. When the moving object detection processing in another temperature range is still left, the processing returns to step #301 to perform imaging, the moving object detection processing, and the imaging condition determination processing.

Hereinafter, imaging, the moving object detection processing, and the imaging condition determination processing are performed in a temperature range of 50° C. to 100° C. and in a temperature range of 10° C. to 60° C. in this order. When, as shown in FIGS. 16 and 17, for example, the percentages of pixels in a temperature range of less than 10° C. on the low-temperature side and in a temperature range of 60° C. and more on the high-temperature side in a temperature range of 10° C. to 60° C. are each less than 20%, it is determined that imaging and the moving object detection processing in the other temperature ranges are not performed.

When the temperature range that may be changed is preset to four ranges, −10° C. to 25° C., 10° C. to 60° C., 50° C. to 100° C., and 85° C. to 140° C., an upper limit can be placed on the number of times of the processing in steps #301 to #303 in FIG. 13. When it is determined that there is a possibility that the gas can be detected (the percentage of pixels is high) on the low-temperature side in a temperature range of 85° C. to 140° C., the temperature range may be decreased to −10° C. to 25° C. or 10° C. to 60° C. to continue the processing.

### Third Embodiment

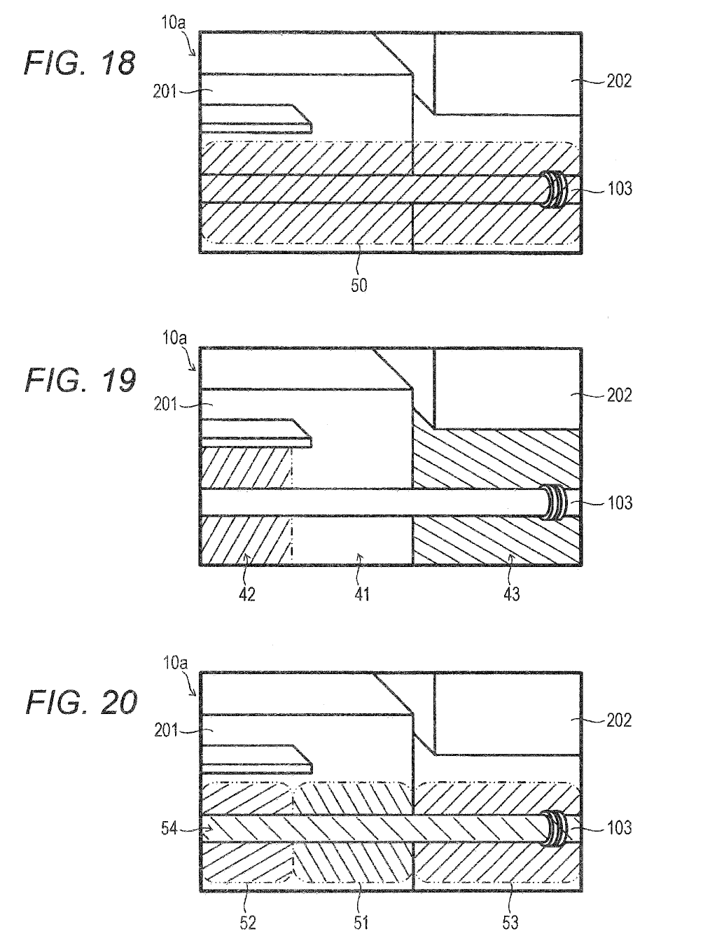

Next, a gas detector according to a third embodiment of the present invention will be described with reference to FIG. 18. FIG. 18 is an explanatory diagram illustrating an area monitored by the gas detector. A basic configuration of this embodiment is identical to those of the first and second embodiments described earlier, and thus components identical to those in those embodiments are denoted by the same reference numerals as before and will not be described.

For example, in an image area 10a imaged by an imaging unit 10 shown in FIG. 18, a scene (background) including a pipe 103 and buildings 201, 202 is present as an object and seen on the image. For this, a gas detector 1 in the third embodiment sets a monitoring area 50 in a portion in the image area 10a. For the monitoring area 50, an area surrounding the pipe 103 to be monitored, defined with the pipe 103 at the center is set.

Then, the gas detector 1 determines a temperature range of the imaging unit 10 in which a gas can be imaged in the monitoring area 50, and performs imaging and moving object detection processing. This reduces a load related to gas detection processing.

Alternatively, a monitoring area 50 extending asymmetrically upward and downward with respect to the pipe 103 (monitoring reference position) may be set in consideration of the type of gas to be monitored. For example, a gas such as methane is of a lower specific gravity than air, and thus moves upward when leaking from the pipe 103. Therefore, it may be preferable to set a monitoring area that is larger above the pipe 103 than below.

### Fourth Embodiment

Next, a gas detector according to a fourth embodiment of the present invention will be described with reference to FIGS. 19 and 20. FIG. 19 is an explanatory diagram illustrating an image area of an imaging unit of the gas detector, and FIG. 20 is an explanatory diagram illustrating areas monitored by the gas detector. A basic configuration of this embodiment is identical to those of the first and second embodiments described earlier, and thus components identical to those in those embodiments are denoted by the same reference numerals as before and will not be described.

For example, in an image area 10a imaged by an imaging unit 10 shown in FIG. 19, a scene (background) including a pipe 103 and buildings 201, 202 is present as an object and seen on the image. In the image area 10a, portions of a sunny place 41, shade 42, aground surface 43, and a pipe 103 have different temperatures. For these portions, it is difficult to perform gas detection in a single temperature range.

Thus, as shown in FIG. 20, the gas detector 1 in the fourth embodiment sets section monitoring areas 51, 52, 53, and 54 corresponding to the sunny place 41, the shade 42, the ground surface 43, and the pipe 103, respectively, in a portion in the image area 10a. Although a portion of the pipe 103 in the image area 10a is a sunny place, it is sectioned off as an area different from the sunny place 41, which is another area of the sunny place. That is, the section monitoring area 54 corresponding to the pipe 103 is an area different from the section monitoring areas 51, 52, and 53 corresponding to the sunny place 41, the shade 42, and the ground surface 43.

Then, the gas detector 1 determines temperature ranges of the imaging unit 10 in which a gas can be imaged in the section monitoring areas 51, 52, 53 and 54, individually, and performs imaging and moving object detection processing. This further reduces a load related to gas detection processing.

As in the first to fourth embodiments, the gas detector 1 includes the imaging unit 10 for imaging a gas, the imaging condition determination unit 21 for determining a temperature range of the imaging unit 10 in which the gas can be imaged, and the gas detection unit 22 for detecting the gas from moving infrared images taken for a predetermined period of time in a temperature range determined by the imaging condition determination unit 21.

This configuration allows the temperature range of the imaging unit 10 in which the gas can be imaged to be suitably set. This makes it possible to accommodate imaging situations such as monitoring time periods and weathers to detect a gas with high accuracy.

In the gas detector 1 in the first embodiment, the imaging condition determination unit 21 determines a temperature range before moving images are taken by the imaging unit 10. In the gas detector 1 in the second embodiment, the imaging condition determination unit 21 determines a temperature range after moving images are taken by the imaging unit 10.

When a temperature range over a relatively wide range is divided into a plurality of temperature ranges of relatively narrow ranges, these configurations increase the possibility of eliminating the need for performing gas detection in all the divided temperature ranges. Thus, gas detection can be performed efficiently.

The gas detection unit 22 detects a gas from moving infrared images by the moving object detection processing.

This configuration allows high-accuracy and efficient gas detection.

A temperature range has a predetermined temperature upper limit and a predetermined temperature lower limit.

This configuration allows a temperature range over a relatively wide range to be divided into a plurality of temperature ranges of relatively narrow ranges. Thus, a temperature range of the imaging unit 10 in which a gas can be imaged can be suitably set, and the gas can be detected with high accuracy.

In the gas detector 1, the gas presence/absence determination unit 23 performs a gas presence/absence determination based on the results of gas detection by the gas detection unit 22.

This configuration allows a user of the gas detector 1 to easily grasp the presence or absence of a gas in an image area imaged by the imaging unit 10.

In the gas detector 1, the gas presence/absence determination unit 23 estimates an area where a gas is present based on the results of gas detection by the gas detection unit 22.

This configuration allows a user of the gas detector 1 to easily grasp an area where a gas is highly likely to be present in an image area imaged by the imaging unit 10.

The imaging condition determination unit 21 determines a temperature range in which the background of an image area imaged by the imaging unit 10 can be imaged.

This configuration facilitates the discerning of the difference between a gas and the background of a space (area) where the gas is present. This allows high-accuracy detection of a gas.

The gas detector 1 in the third or fourth embodiment sets the monitoring area 50 or the section monitoring areas 51, 52, 53, and 54 in a portion in the image area 10a imaged by the imaging unit 10, and determines a temperature range of the imaging unit 10 in which the gas can be imaged in the monitoring area 50 or the section monitoring areas 51, 52, 53, and 54.

According to this configuration, in the image area 10a, the monitoring area 50 or the section monitoring areas 51, 52, 53, and 54, which are areas smaller than the image area 10a, are set. Then, by determining a temperature range and performing imaging and the moving object detection processing on the monitoring area 50 or the section monitoring areas 51, 52, 53, and 54, a load related to the gas detection processing can be reduced.

The gas detector 1 in the fourth embodiment sets the plurality of section monitoring areas 51, 52, 53, and 54 in a portion in the image area 10a imaged by the imaging unit 10, and images them in different temperature ranges, to detect the gas from moving infrared images taken in the different temperature ranges for each of the section monitoring areas 51, 52, 53, and 54.

This configuration allows setting of the section monitoring areas 51, 52, 53, and 54 (see FIG. 20) corresponding to the sunny place 41, the shade 42, the ground surface 43, and the pipe 103 (see FIG. 19), respectively, for example. Then, by determining temperature ranges and performing imaging and the moving object detection processing on the section monitoring areas 51, 52, 53, and 54, individually, a load related to the gas detection processing can be further reduced.

The gas detector 1 in the third or fourth embodiment sets the monitoring area 50 or the section monitoring areas 51, 52, and 53 extending asymmetrically in upper and lower directions with respect to a monitoring reference position (such as a pipe) in a portion in the image area 10a imaged by the imaging unit 10.

This configuration allows setting of a monitoring area of a shape and a size appropriate for a gas of a lower or higher specific gravity than air. This makes it possible to adapt to many types of gas having different characteristics to detect a gas with high accuracy.

The gas detector 1, in which the imaging unit 10 has an infrared sensor as the image pickup device 13, changes the integration time of electric signals corresponding to pixels of the infrared sensor, or changes the reference potential of the infrared sensor, to switch temperature ranges.

This configuration allows temperature ranges of the imaging unit 10 to be easily changed by software-based control.

The gas detector 1, in which the imaging unit 10 has an infrared sensor as the image pickup device 13 and the filter 12 through which infrared radiation passes, switches temperature ranges by selecting the use or disuse of the filter 12, or providing a plurality of types of filters 12 that transmit different wavelength bands of infrared radiation and switching them, or using a filter 12 that can change the wavelength band of infrared radiation it transmits or transmittance.

This configuration allows temperature ranges of the imaging unit 10 to be easily changed by hardware-based control.

Although the embodiments of the present invention have been described above, the scope of the present invention is not limited to them. Various changes may be added to them without departing from the gist of the present invention for implementation.

For example, although four temperature ranges, −10° C. to 25° C., 10° C. to 60° C., 50° C. to 100° C., and 85° C. to 140° C., are used in the above embodiments, the temperature range is not limited to them. The temperature range may be set to other temperature ranges, or less than four or more than four temperature ranges may be used.

Further, for numerical values set as conditions such as a condition of the number of effective pixels in the imaging condition determination processing (e.g. 30% in the first embodiment) and a condition of the number of pixels for a shift to another temperature range (e.g. 20% in the second embodiment), other numerical values may be used.

The present invention is usable in gas detectors for detecting a gas present in a predetermined area.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A gas detector comprising:
an infrared camera that images a gas; and
a controller including at least an electronic component, wherein
the controller determines a temperature range of the infrared camera in which the gas can be imaged, and
detects the gas from moving infrared images taken for a predetermined period of time in the temperature range determined.

2. The gas detector according to claim 1, wherein the controller determines the temperature range before or after moving images are taken by the infrared camera.

3. The gas detector according to claim 1, wherein the controller detects the gas from the moving infrared images by moving object detection processing.

4. The gas detector according to claim 1, wherein the temperature range has a predetermined temperature upper limit and a predetermined temperature lower limit.

5. The gas detector according to claim 1, wherein a determination of presence or absence of the gas is performed based on a result of gas detection by the controller.

6. The gas detector according to claim 1, wherein an area where the gas is present is estimated based on a result of gas detection by the controller.

7. The gas detector according to claim 1, wherein the controller determines the temperature range in which a background of an image area imaged by the imaging unit can be imaged.

8. The gas detector according to claim 1, wherein a monitoring area is set in a portion in an image area imaged by the infrared camera, and the temperature range of the infrared camera in which the gas can be imaged in the monitoring area is determined.

9. The gas detector according to claim 1, wherein a plurality of section monitoring areas is set in a portion in an image area imaged by the infrared camera and is imaged in a plurality of the different temperature ranges, and the gas is detected from moving infrared images taken in the different temperature ranges for each of the section monitoring areas.

10. The gas detector according to claim 8, wherein the monitoring area or the section monitoring areas extending asymmetrically in upper and lower directions with respect to a monitoring reference position are set in a portion in an image area imaged by the infrared camera.

11. The gas detector according to claim 1, wherein the infrared camera has an infrared sensor as an image pickup device, and changes an integration time of electric signals corresponding to pixels of the infrared sensor or changes a reference potential of the infrared sensor to switch the temperature range.

12. The gas detector according to claim 1, wherein the infrared camera has an infrared sensor as an image pickup device and a filter through which infrared radiation passes, and switches the temperature range by selecting use or disuse of the filter, or providing a plurality of types of the filters that transmit different wavelength bands of infrared radiation and switching them, or using the filter that can change the wavelength band of infrared radiation it transmits or transmittance.
